(19) United States
(12) Patent Application Publication
(10) Pub. No.: US 2026/0219635 A1
(43) Pub. Date: Jul. 30, 2026

(54) TOURBILLON MECHANISM FOR A TIMEPIECE MOVEMENT

(71) Applicant: Greubel Forsey S.A., La Chaux-de-Fonds (CH)

(72) Inventors: Florian CORNEILLE, Mathay (FR); Christophe HELD, Peseux (CH)

(21) Appl. No.: 19/148,553

(22) PCT Filed: Feb. 9, 2024
(86) PCT No.: PCT/EP2024/053381

§ 371 Date: Jul. 16, 2025

(30) Foreign Application Priority Data
Feb. 15, 2023 (EP) 23156814.8

(51) Int. Cl. G04B 17/28

(52) U.S. Cl. CPC G04B 17/285

(57) ABSTRACT

The invention relates to a tourbillon mechanism (1) for a timepiece movement, the tourbillon mechanism comprising: —a rotary support (3) pivotably mounted on a base (5) so as to pivot about a first axis of rotation (A1) and arranged to be rotated by a drive source(S); —an oscillator (7) pivotably mounted on the rotary support (3) so as to pivot about a second axis of rotation (A2); —a blocking member (11) mounted on the rotary support (3) and arranged to block and release rotations of the rotary support (3) under the control of the rotations of the oscillator (7); —an escape wheel (9) mounted so as to rotate as one with the base (5) and arranged to co-operate with the blocking member (11); —a direct impulse member (15) mounted on the second axis of rotation (A2) and arranged to co-operate with the escape wheel (9) so as to deliver an impulse to the oscillator (7) during the pivoting of the rotary support (3).

### TECHNICAL FIELD

The present invention relates to the field of watchmaking. More specifically, it relates to a tourbillon mechanism for a timepiece movement.

### PRIOR ART

The document CH701490 describes a tourbillon with a ‘Potter’-type escapement which has a fixed escape wheel.

In this mechanism, the balance-hairspring oscillator is mounted in a rotating cage arranged to be rotated by a drive source, the axis of rotation of the balance wheel being coaxial with that of the cage. The cage also carries an anchor, which on the one hand co-operates with the oscillator in a known manner, and on the other hand co-operates with a fixed escape wheel rotationally fixed to a frame element.

This construction minimizes the number of elements carried by the cage and the angular inertia of the tourbillon, and allows a relatively fast rotation of the cage, of the order of a few seconds, which is significantly faster than the 30 seconds to several minutes of a conventional tourbillon.

This type of escapement has also been used in multi-axis tourbillons, notably the triple-axis tourbillons used in the MB&F Legacy Machine Thunderdome. These triple-axis tourbillons have rotational speeds for the three cages of 8, 12 and 20 seconds respectively, the escape wheel being attached to the intermediate cage.

However, Potter-type escapements generate relatively high friction, resulting in fairly low efficiency and adversely affecting the power reserve.

In one of its embodiments, the document CH718204 discloses an escapement in which a fixed escapement crown with internal teeth co-operates with a linear-displacement escapement member which delivers indirect impulses to the balance-hairspring oscillator in a manner comparable to a conventional Swiss lever escapement. This system is very delicate and fragile, and is therefore difficult to perfect. In addition, the relatively high inertia of the chassis and the components it supports, as well as the friction generated by the displacements of the escapement member, result in relatively small indirect impulses (transmitted to the oscillator at the start of pallet release) and likewise fairly low efficiency, which again has an adverse effect on the power reserve.

The object of the invention is therefore to propose a tourbillon mechanism in which the aforementioned disadvantages are at least partially overcome.

### DISCLOSURE OF THE INVENTION

More specifically, the invention relates to a tourbillon mechanism for a timepiece movement, as defined in claim 1. This mechanism comprises:
a rotary support, such as a plate, a cage, or similar, pivotably mounted on a base about a first axis of rotation and arranged to be rotated by a drive source, such as a mainspring housed in a barrel;
an oscillator, typically a balance-hairspring of any known type, pivotably mounted on the rotary support so as to pivot about a second axis of rotation;
a blocking member mounted on the rotary support and arranged to block and release rotations of the rotary support under the direct or indirect control of the rotations of the oscillator;
an escape wheel mounted rotationally fixed to the base and arranged to co-operate with the blocking member;
a direct impulse member (such as an impulse pallet) mounted on the second axis of rotation and arranged to co-operate with the escape wheel (in particular through direct co-operation with the teeth of the escape wheel) so as to deliver an impulse to the oscillator during the pivoting of the rotary support.

The escapement described above is of the ‘direct impulse’ type, and offers high efficiency compared to a conventional lever escapement, which makes it possible to increase the power reserve of the movement in which the tourbillon mechanism is integrated, while maintaining the relatively high rotational speed of the rotary support of the ‘Potter’ escapement. It should be noted that the term ‘tourbillon’ is to be understood in the broad sense.

Advantageously, the blocking member is a detent lever pivotably mounted on the rotary support so as to pivot about a third axis of rotation. This detent lever is arranged to co-operate with a release pallet mounted on the second axis in order to pivot the detent lever to initiate rotation of the rotary support, the detent lever being subjected to a restoring force tending to keep it engaged with the escape wheel.

Advantageously, a retractable finger is mounted on the detent lever so as to rotate about a fourth axis of rotation in such a way as to co-operate with the release pallet in order to cause the detent lever to pivot in order to initiate rotation of the rotary support during a first vibration of the oscillator, and to retract in order to allow the release pallet to pass during a second vibration of the oscillator.

Advantageously, the retractable finger is subjected to a restoring force provided by an elastic element which tends to keep the retractable finger bearing against a stop carried by the detent lever.

Alternatively, the blocking member is an anchor.

Advantageously, the second axis of rotation is distinct from the first axis of rotation, but these two axes may also be coincident.

Advantageously, the second axis of rotation forms an angle of 1° to 90°, preferably 10° to 80°, even more preferably 20° to 70°, with respect to the first axis of rotation, which improves running in the horizontal and vertical positions in the chronometric test.

### BRIEF DESCRIPTION OF THE DRAWINGS

Other details of the invention will become clearer upon reading the following description, in reference to the accompanying drawings, in which:

FIGS. 1 and 2 are schematic isometric views of a non-limiting embodiment of a tourbillon mechanism according to the invention, at rest;

FIGS. 3 to 9 are schematic plan views of a mechanism according to FIGS. 1 and 2 illustrating the operating sequence, with the balance wheel and base omitted.

### EMBODIMENTS OF THE INVENTION

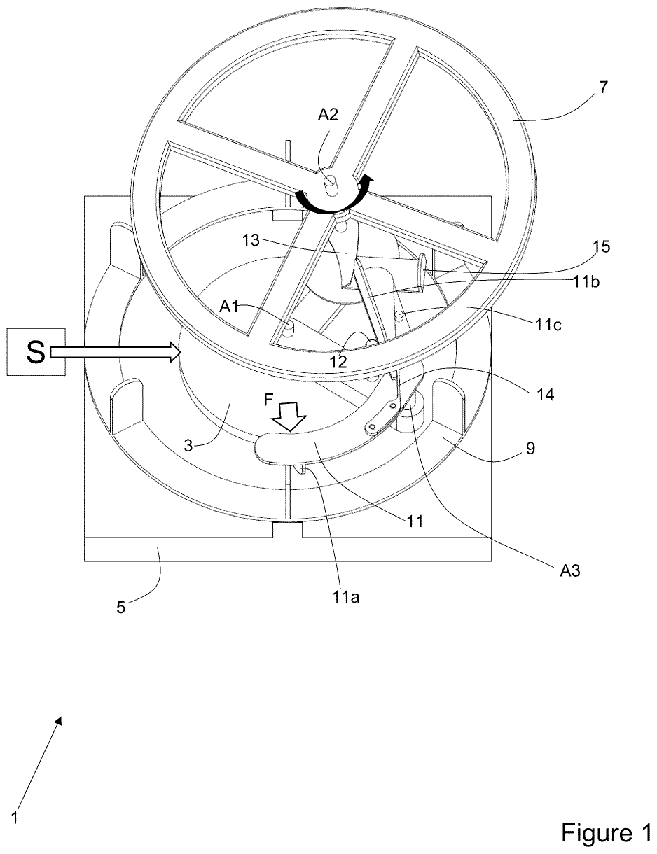

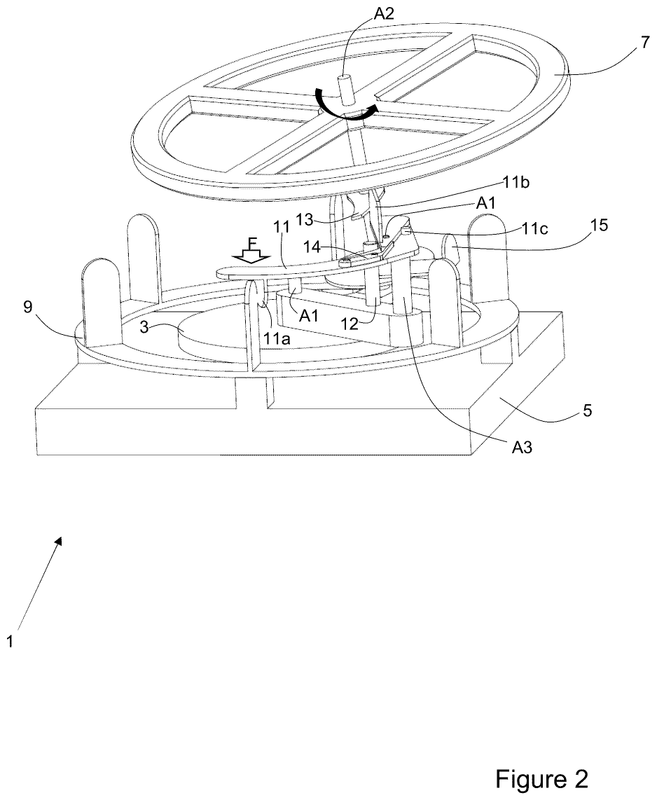

FIGS. 1 and 2 schematically illustrate a tourbillon mechanism 1 according to the invention, the term ‘tourbillon’ being understood in the broad sense. This mechanism 1 comprises a rotary support 3 pivotably mounted on a base 5 so as to pivot about a first axis of rotation A1 and arranged to be rotated by means of a drive source S, such as a barrel housing a mainspring, in a known manner. The drive source S is shown schematically in FIG. 1, and the kinematic link enabling it to drive the rotary support 3 in rotation is illustrated in the form of an arrow; this kinematic link can take any known form, including toothed wheels, chains, belts, or the like.

In the situation illustrated by FIGS. 1 and 2, the rotary support 3 is at rest, the drive source S tending to pivot it clockwise according to the orientation of the figures, as will become clear in the following. In the illustrated embodiment, the rotary support 3 is a plate provided with bars which are rotationally-integrated therewith, the plate being supported in a floating manner by suitable bearings; however, the rotary support 3 can also be formed by a simple plate, a floating cage, or a cage pivoted in a conventional manner between bearings, or any other suitable structure.

The base 5 may be attached to the movement frame, or form part thereof, or may alternatively be movable if the tourbillon mechanism 1 is designed to have two axes or three axes, in accordance with the principles of Richard Good's double-axis and triple-axis tourbillons, or those of the MB&F Legacy Machine Thunderdome mentioned in the introduction.

The rotary support 3 carries a balance-hairspring oscillator 7 (the hairspring not being illustrated, but conventionally arranged to provide a return torque to cause the balance wheel 7 to oscillate, in a known manner) mounted so as to pivot on the rotary support 3 about a second axis of rotation A2. Of course, other suitable spring shapes known to a person skilled in the art (helical, spherical, double spiral, etc.) can be envisaged. This axis A2 may be coincident with the axis A1 or, as illustrated, offset from it. In addition, the axis A2 can be inclined with respect to the axis A1, at an angle of 1° to 90°, preferably 10° to 80°, even more preferably 20° to 70°, if necessary, instead of being parallel thereto.

Turning now to the escapement, the escape wheel 9 is coaxial with the axis A1, and is rotationally fixed to the base 5.

As illustrated, the escape wheel 9 is hollow at its center and has edge teeth; however, it may have internal teeth as in the document CH701490, or be in the form of a crown with external teeth.

The key point of the invention is that the escapement is of the direct impulse type, i.e. at least a portion of the oscillator's driving force is provided by the co-operation between, on the one hand, the escape wheel and, on the other hand, a structure carried by the balance wheel staff (such as an impulse pallet), without passing through a member which also acts as a blocking member (such as an anchor, which provides indirect impulses). The conventional example of an escapement which drives the oscillator purely by direct impulse is the detent escapement, in which the escape wheel blocking member only blocks and releases the escape wheel, the impulses being delivered directly, once per oscillation, by the co-operation between the teeth of the escape wheel and an impulse pallet rotationally fixed to the staff of the balance wheel. The conventional example of an indirect impulse escapement is the Swiss anchor escapement, in which the anchor serves as both a blocking and an impulse-transmitting member, the co-operation between the tips of the escape wheel teeth and the oblique impulse planes of the pallets generating the impulses which are transmitted to the oscillator by the lever to the impulse pin. Finally, an example of a ‘hybrid’ direct impulse escapement which incorporates not only direct but also indirect impulses is the Omega-Daniels coaxial escapement, in which the impulses in one direction of rotation of the oscillator are delivered by the co-operation between the escape wheel and an impulse pallet in a similar way to the case of a detent escapement, while in the other direction of rotation of the oscillator the impulses are delivered via an anchor.

Returning to the tourbillon mechanism 1 of the invention, which is a direct impulse tourbillon mechanism as mentioned above, for this purpose the rotary support 3 carries, as a blocking member, a detent lever 11, pivotably mounted on the rotary support 3 so as to pivot about a third pivot axis A3. Close to, or at, a first end of the detent lever 11, there is a blocking pallet 11a which co-operates with the teeth of the escape wheel 9 to block and release the rotation of the rotary support 3. A restoring force F is provided, which tends to keep the blocking pallet 11a engaged with a tooth of the escape wheel 9, as is the case in FIGS. 1 and 2. This force F may be provided by a suitable elastic element, and the detent lever 11 may alternatively co-operate directly with the teeth of the escape wheel 9 instead of being provided with a pallet 11a. A first stop 12, mounted on the rotary support 3, is arranged to limit the rotation of the detent lever 11 and thus limit its maximum position when it is under the effect of the force F.

The other end of the detent lever 11 carries a retractable finger 11b which co-operates with a release pallet 13, this latter being rotationally-integrated with the balance wheel 7. The angle of the end of the release pallet may be parallel to the second axis A2 or may be parallel to the first axis A1 at the point where it co-operates with the retractable finger 11b, or any intermediate angle, or it may be convex in shape. In addition, this release pallet 13 can take any other suitable form, such as a finger, a pin, or any other element fulfilling this function.

The retractable finger 11b is pivotably mounted on the detent lever 11 so as to pivot about an axis A4 and is subjected to a restoring force provided by an elastic element 14 in order to force it against a second stop 11c so that the release pallet 13 can co-operate with the retractable finger 11b so as to pivot the detent lever 11 to move the blocking pallet 11a away from the toothing of the escape wheel 9 when the release pallet 13 pivots in a first direction (counter-clockwise according to the orientation of the figures). When the release pallet 13 co-operates with the retractable finger 11b in the other direction of rotation (clockwise), the retractable finger 11b can rotate relative to the detent lever 11 against the effect of the elastic element 14 to allow the release pallet 13 to pass.

In order to deliver impulses to the balance wheel 7, an impulse pallet 15 is also provided, rotationally-integrated with the balance wheel 7 and is arranged to co-operate directly with the teeth of the escape wheel 9 when the rotary support 3 pivots. When the rotary support 3 is at rest (as in FIGS. 1 and 2), the teeth of the escape wheel 9 are out of reach of the impulse pallet 15, and no interaction between these elements takes place.

Although a detent system has been illustrated in the figures, other types of direct impulse escapement are possible. For this purpose, particular mention may be made of a Swiss lever escapement (which acts as a blocking member and delivers indirect impulses to the balance wheel 7 in a known manner) combined with an impulse pallet 15 is rotationally-integrated with the balance wheel 7 and which co-operates directly with the teeth of the escape wheel 9 or of an impulse wheel with contrate or internal teeth, which is mounted rotationally-integrated with the escape wheel 9 on one side or the other thereof, or any other direct impulse escapement (such as an Omega-Daniels escapement) which is suitable for being modified to include a fixed escape wheel 9. In addition, the blocking member 11 may be a cam or any other suitable element.

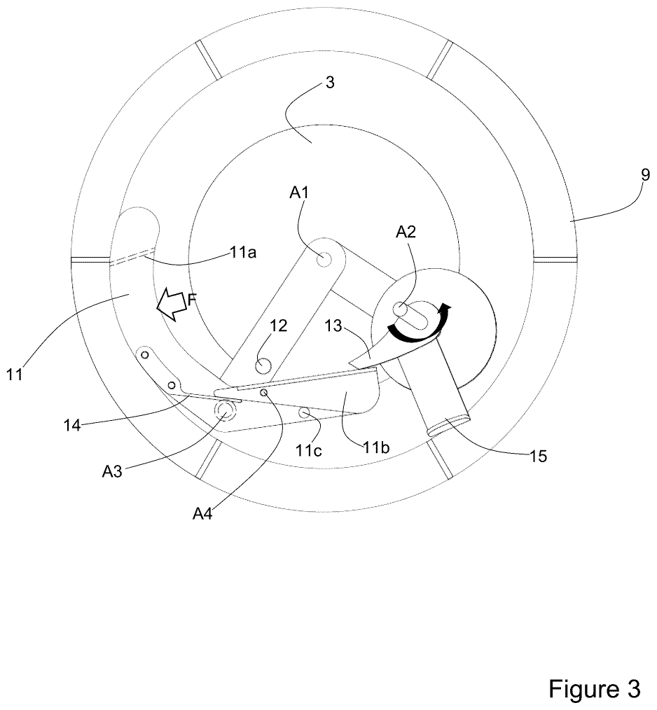

The operating sequence of the tourbillon 1 according to the invention will now be described with reference to FIGS. 3 to 9.

As a reminder, in the views shown in FIGS. 1 and 2 the rotary support 3 is at rest and the blocking pallet 11a is in contact with a tooth of the escape wheel 9. The balance wheel 7 is in the process of pivoting counter-clockwise and the release pallet 13 comes into contact with the second end 11b of the detent lever 11.

Looking now at FIG. 3, the release pallet 13 has begun to co-operate with the retractable finger 11b so as to pivot the detent lever 11 about its pivot axis A3 and lift the blocking pallet 11a, which is about to pass over the top of a tooth of the escape wheel 9. At the same time, the impulse pallet 15 enters the circle defined by the teeth of the escape wheel 9.

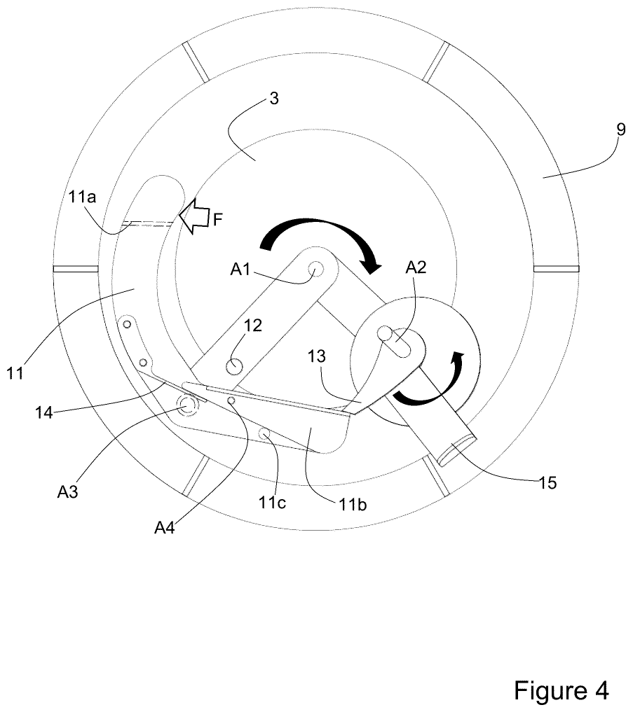

In FIG. 4, the release pallet 13 has lifted the detent lever 11 so that the blocking pallet 11a leaves the toothing of the escape wheel 9, and the rotary support 3 begins to pivot clockwise. In so doing, the impulse pallet 15 comes into contact with a tooth of the escape wheel 9, and receives an impulse from this tooth.

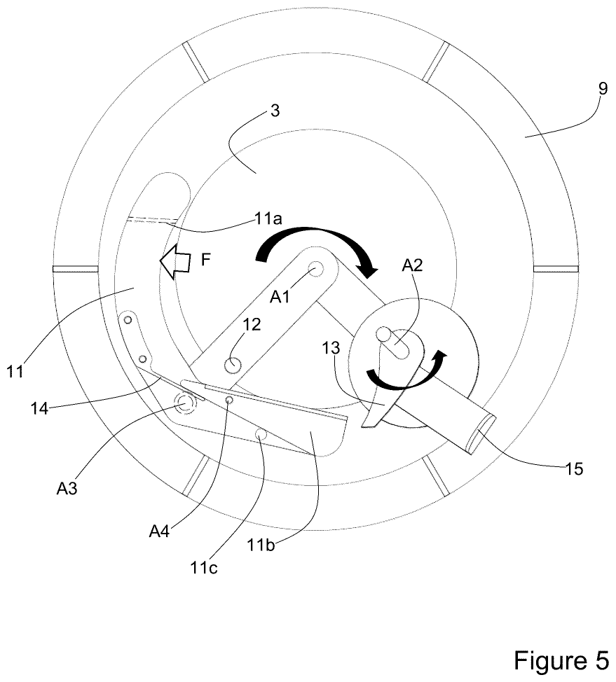

By pivoting further, and as illustrated in FIG. 5, the release pallet 13 no longer co-operates with the retractable finger 11b, and the restoring force F begins to cause the detent lever 11 to pivot counter-clockwise about its pivot axis A3.

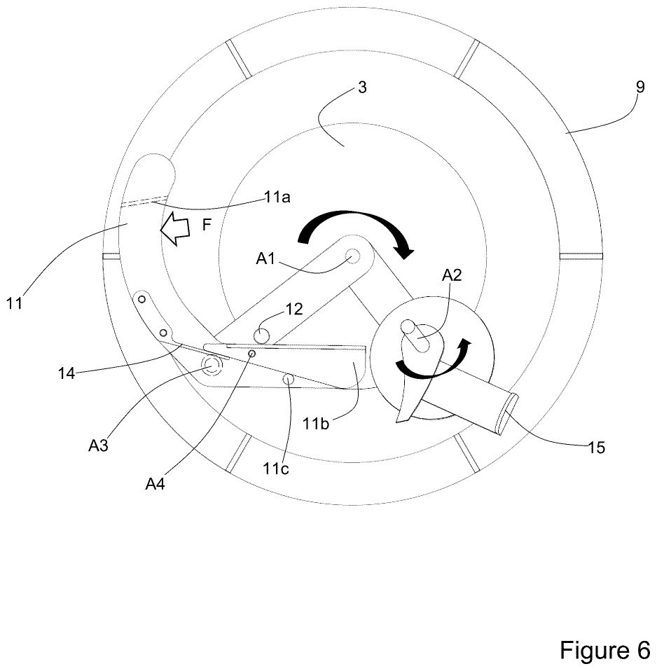

In FIG. 6, the detent lever 11 has returned to its initial position, with reference to the rotary support 3, under the effect of the restoring force F, and again penetrates into the toothing of the escape wheel 9, its angular position with respect to the rotary support 3 being defined by the first stop 12 against which the detent lever 11 bears.

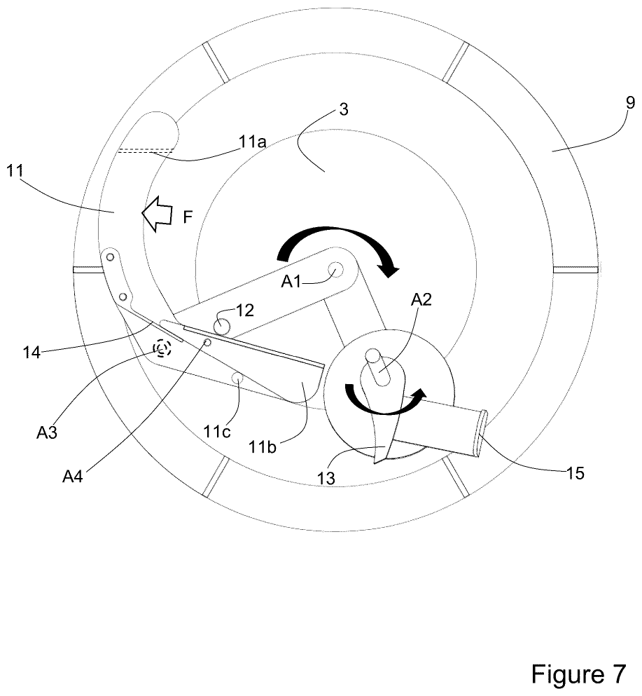

The rotary support 3 continues to pivot clockwise under the effect of the drive source, as illustrated in FIG. 7.

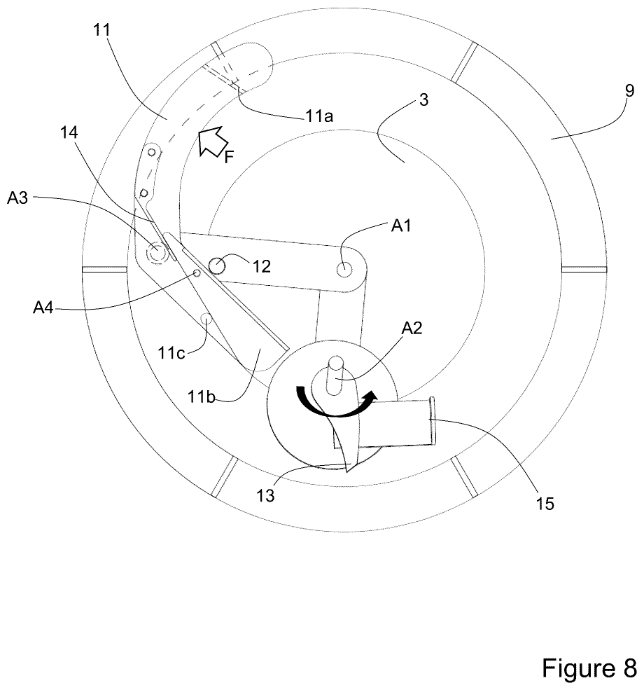

FIG. 8 illustrates the situation in which the rotary support 3 is again at rest, the blocking pallet 11a now being in contact with the next tooth of the escape wheel 9. The balance wheel 7 is free to finish its counter-clockwise vibration and to start its clockwise vibration.

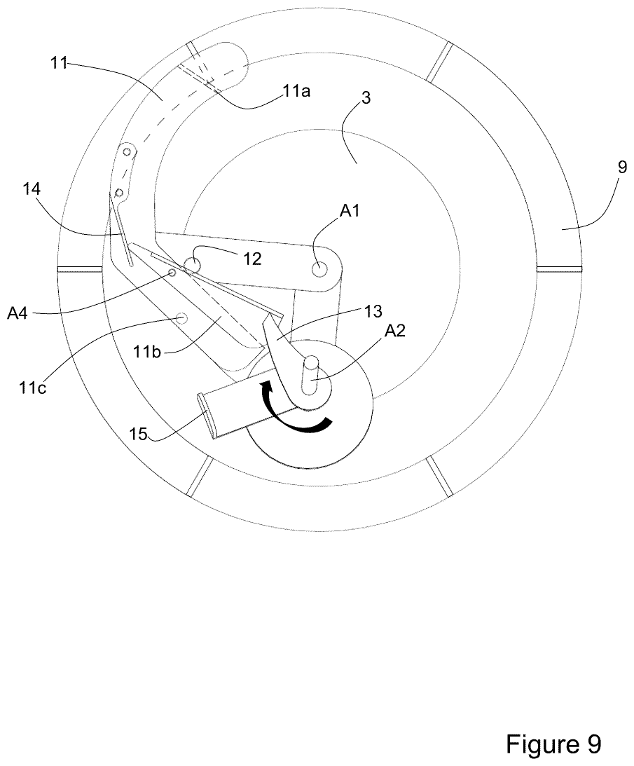

In doing so, and as illustrated in FIG. 9, when the release pallet 13 comes into contact with the retractable finger 11b, this latter is lifted against the force provided by the elastic element 14. Since the first stop 12 is long enough to co-operate with the detent lever 11 but does not reach the retractable finger 11b, this latter is not prevented from pivoting about its axis of rotation A4 to allow the release pallet 13 to pass.

The operating cycle then repeats itself.

As far as materials are concerned, the full range of materials used in contemporary watchmaking can be considered (metals, non-metals such as silicon, silicon compounds, synthetic diamond, sapphire, structurable glasses, ceramics, glass-ceramics, metallic glasses, polymers, composites, materials suitable for additive manufacturing, etc.).

In addition, the detent lever 11 may be provided in one piece, integral with the elastic element which provides the restoring force F. Furthermore, the detent lever 11 (or more generically the blocking element which may, as a reminder, alternatively be a lever or the like) may be supported on the rotary support 3 by a flexible pivot system, its pivot axis A3 therefore being virtual and defined by the flexible pivots. More generally, an implementation with flexible pivots makes it possible, for example, to eliminate the first stop 12 if this latter is integrated in a detent lever with flexible pivots, and also makes it possible to render at least some axes virtual instead of physical.

As far as the form and arrangements of the various elements is concerned, there are no restrictions, as long as the functionality described above is obtained.

The present description has been provided as a non-limiting illustration of the invention. A person skilled in the art will be able to make additions to its scope, without, however, departing from the scope of the invention as defined by the claims.

1.-9. (canceled)

10. Tourbillon mechanism for a timepiece movement, the tourbillon mechanism comprising:
a rotary support pivotably mounted on a base so as to pivot about a first axis of rotation and arranged to be rotated by a drive source;
an oscillator pivotably mounted on the rotary support so as to pivot about a second axis of rotation;
a blocking member mounted on the rotary support and arranged to block and release rotations of the rotary support under the control of the rotations of the oscillator;
an escape wheel mounted rotationally fixed to the base and arranged to co-operate with the blocking member;
a direct impulse member mounted on the second axis of rotation and arranged to co-operate with the escape wheel so as to deliver an impulse to the oscillator during the pivoting of the rotary support.

11. Tourbillon mechanism according to claim 10, wherein the blocking member is a detent lever pivotably mounted on the rotary support so as to pivot about a third axis of rotation and arranged to co-operate with a release pallet mounted on the second axis in order to pivot the detent lever to initiate rotation of the rotary support, the detent lever being subjected to a restoring force tending to keep it engaged with the escape wheel.

12. Tourbillon mechanism according to claim 11, wherein a retractable finger is mounted on the detent lever so as to rotate about a fourth axis of rotation in such a way as to co-operate with the release pallet in order to cause the detent lever to pivot in order to initiate rotation of the rotary support during a first vibration of the oscillator, and to retract in order to allow the release pallet to pass during a second vibration of the oscillator.

13. Tourbillon mechanism according to claim 11, wherein the retractable finger is subjected to a restoring force provided by an elastic element which tends to keep the retractable finger bearing against a stop carried by the detent lever.

14. Tourbillon mechanism according to claim 10, wherein the blocking member is an anchor.

15. Tourbillon mechanism according to claim 10, wherein the second axis of rotation is distinct from the first axis of rotation.

16. Tourbillon mechanism according to claim 10, wherein the second axis of rotation forms an angle of 1° to 90° with respect to the first axis of rotation.

17. Tourbillon mechanism according to claim 16, wherein the second axis of rotation forms an angle of 10° to 80° with respect to the first axis of rotation.

18. Tourbillon mechanism according to claim 17, wherein the second axis of rotation forms an angle of 20° to 70° with respect to the first axis of rotation.

19. Timepiece movement comprising a tourbillon mechanism according to claim 10.

20. Timepiece comprising a movement according to claim 19.
